(19) United States
(12) Patent Application Publication
(10) Pub. No.: US 2008/0020710 A1
(43) Pub. Date: Jan. 24, 2008

(54) Method and apparatus for positioning node by using time offset information

(75) Inventors: Wan Jin Kim, Yongin-si (KR); Min Seop Jeong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/703,198

(22) Filed: Feb. 7, 2007

(30) Foreign Application Priority Data
Jul. 18, 2006 (KR) 10-2006-0066706

(51) Int. Cl. H04B 7/26

(52) U.S. Cl. 455/67.11

(57) ABSTRACT

There is provided a node position measurement apparatus and method including sequentially transmitting measurement impulses corresponding to a plurality of base stations, respectively, to at least one node; receiving time offset information that is a difference in time of receiving the measurement impulses, from the node receiving the measurement impulses; and measuring a position of the node based on the time offset information.

### CROSS-REFERENCE TO RELATED APPLICATIONS

This application claims priority from Korean Patent Application No. 10-2006-0066706, filed on Jul. 18, 2006, in the Korean Intellectual Property Office, the disclosure of which is incorporated herein by reference.

### BACKGROUND OF THE INVENTION

1. Field of the Invention

Methods and apparatuses consistent with the present invention relate to node position measurement, and more particularly, to node position measurement using time offset information, which is capable of reducing a time for measuring a position of each node by using time offset information in an indoor positioning field in which multi-nodes exist.

2. Description of the Related Art

In a conventional two-way method used in an indoor positioning field, a plurality of base stations installed at fixed positions sequentially transmit a signal of an identification (ID) assigned to each of the base stations to a node at a predetermined time interval, the node receives the ID signal of the plurality of the base stations, and a signal corresponding to the ID signal received from the base station is transmitted to each of the base stations at a predetermined time interval. In this case, the time interval and an order of transmitting the ID signal from the base station are previously established. In this case, a time for receiving the ID signal from the base station at the node and transmitting the predetermined signal corresponding to the received signal to the base station is previously determined.

FIG. 1 is a diagram illustrating calculating a position of a node according to the related art two-way method, in which two base stations and one node exist.

For convenience of description, the configuration of the system includes the two base stations and one node. However, it is obvious that the system may include a plurality of base stations (hereinafter, referred to as “BS”) and a plurality of nodes.

FIG. 2 is a waveform diagram illustrating transmission and reception between the base station and node shown in FIG. 1. Referring to FIGS. 1 and 2, the conventional node position measurement method will be described.

Base stations BS1 and BS2 transmit ID signals at a predetermined time interval Δt_{offset1}, a node receives the ID signals transmitted from the BS1 and BS2 and transmits a predetermined signal (hereinafter, referred to as “node signal”) corresponding to the ID signal to the BS1 and BS2 after a predetermined amount of time Δt_{delay}. In this case, the node signal transmitted from the node includes ID of the node and Δt_{delay} information.

The base stations BS1 and BS2 receive the node signal transmitted from the node and measure positions of each of the BS1 and BS2 and the node by using the information included in the node signal and a round-trip time Δt_{round} indicating the time for transmitting the signal from each of the base stations BS1 and BS2 and receiving the node signal. Specifically, the position of the node is measured by calculating distances d1 and d2 between the base stations BS1 and BS2, and the node, respectively, and an azimuth θ of the node. Obviously, when the system includes three or more BSs, the position of the node may be measured by calculating distances between each of the BSs, without calculating the azimuth θ.

However, the related art node position measurement method has a disadvantage of consuming a great amount of time to measure the position of the node because the position of the node is measured based on distances calculated at all of the BSs after receiving the node signal at each of the BSs, and calculating the distances between the node and the each of the BSs.

Also, since a plurality of signals is required for performing communications between all of the BSs and the node, and measuring the position of the node, a probability of incurring interference between signals is high.

Also, since the amount of time used for measuring the position of the node increases, processing time and power consumption increase, thereby increasing cost of power consumption and increasing processing time of an entire system.

### SUMMARY OF THE INVENTION

The present invention provides a node position measurement method and apparatus using time offset information, capable of measuring a position of a node by using time offset information between all signals transmitted from a node to a predetermined base station, and received by the predetermined base station.

The present invention also provides a node position measurement method and apparatus using time offset information, capable of reducing a number of transmissions and receptions of a signal, that are required for measuring a position of a node since all nodes transmit time offset information to a predetermined base station.

The present invention: also provides a node position measurement method and apparatus using time offset information, capable of reducing interference between signals and reduced power consumption by reducing a number of transmissions and receptions of a signal.

The present invention also provides a node position measurement method and apparatus using time offset information, capable of reducing a probability of signal interference between nodes by transmitting time offset information of the node to a predetermined base station in a previously assigned time slot.

According to an aspect of the present invention, there is provided a node position measurement method including: sequentially transmitting measurement impulses corresponding to a plurality of base stations, respectively, to at least one node; receiving time offset information that is a difference in time of receiving the measurement impulses, from the node receiving the measurement impulses; and measuring a position of the node based on the time offset information.

The sequentially transmitting measurement impulses may include: transmitting a measurement impulse corresponding to a previously established base station from the plurality of base stations; and sequentially transmitting measurement impulses corresponding to remaining base stations according to a predetermined time interval and a predetermined order.

In the receiving time offset information, base stations established as a receiving base station from the plurality of base stations may receive the time offset information from the at least one node.

The receiving time offset information may include: receiving a plurality of the measurement impulses at the node; calculating a time offset between the measurement impulses, based on the received measurement impulses, at the node; and receiving the time offset information calculated at the node in response to a point in time corresponding to the node, at the previously established base station.

The time offset between the measurement impulses may be calculated based on the measurement impulse received from the previously established base station or may be calculated by a time difference between two sequentially received measurement impulses.

The node may transmit the time offset information in a time slot assigned to the node.

In the measuring a position of the node, the position of the node may be measured by using the time offset information, a round-trip time of the measurement impulse of the previously established base station, and the predetermined time interval.

According to another aspect of the present invention, there is provided a node position measurement apparatus including: a time offset information receiving unit receiving time offset information that is a time difference of receiving measurement impulses corresponding to a plurality of base stations, from at least one node; a node position calculation unit calculating a position of the node, based on the time offset information; and a node position display unit displaying the position of the node.

The time offset information receiving unit may receive the time offset information in a time slot assigned to the node.

The node position calculation unit may calculate the position of the node by using the time offset information received from the node, a time interval of transmitting the measurement impulse between the base stations, and a round-trip time.

### BRIEF DESCRIPTION OF THE DRAWINGS

The above and/or other aspects of the present invention will become apparent and more readily appreciated from the following detailed description of exemplary embodiments, taken in conjunction with the accompanying drawings of which:

FIG. 1 is a system diagram illustrating a related art two-way node position measurement method;

FIG. 2 is a waveform diagram with respect to time, illustrating the related art node position measurement method;

FIG. 3 is a flowchart illustrating a node position measurement method according to an exemplary embodiment of the present invention;

FIG. 4 is a waveform diagram with respect to time, illustrating the node position measurement method according to an exemplary embodiment of the present invention;

FIG. 5 is a flowchart illustrating a node position measurement method in a multi-node environment according to an exemplary embodiment of the present invention;

FIG. 6 is a diagram illustrating a system employing the node position measurement method in the multi-node environment of FIG. 5;

FIG. 7 is a waveform diagram with respect to time, illustrating the node position measurement method in the system of FIG. 6;

FIG. 8 is a waveform diagram with respect to time, illustrating the node position measurement method according to an exemplary embodiment of the present invention; and

FIG. 9 is a diagram illustrating a configuration of a node position measurement apparatus according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

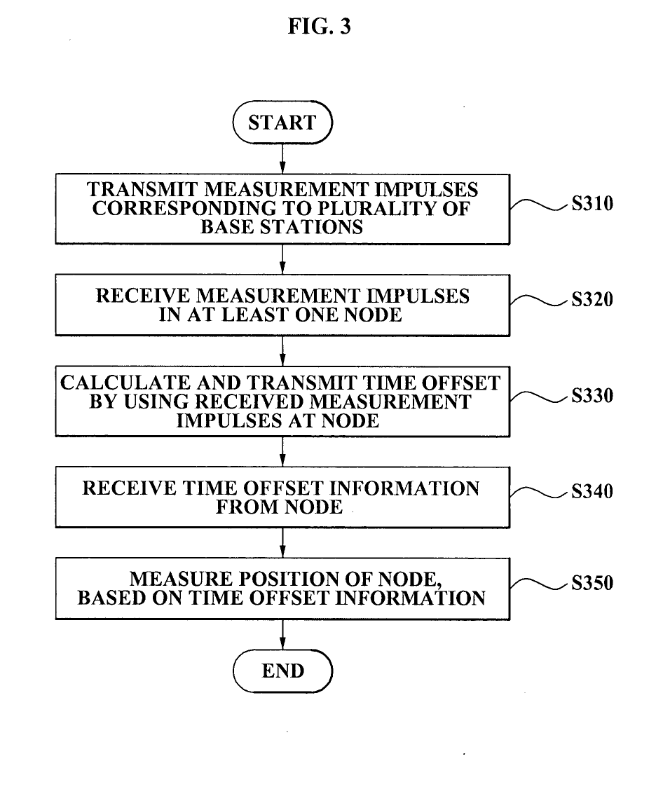

FIG. 3 is a flowchart illustrating a node position measurement method according to an exemplary embodiment of the present invention. Referring to FIG. 3, measurement impulses corresponding to a plurality of base stations are transmitted in operation S310, at least one node receives the measurement impulses and calculates a time offset in operations S320 and S330, time offset information is received from the node in operation S340, and a position of the node is measured by using the time offset information in operation S350.

In this case, an ID is assigned to each of the plurality of base stations and at least one node, and the measurement impulse corresponding to each of the plurality of base stations is transmitted in a predetermined order at a predetermined time interval. The node calculates the time offset by using a time difference between the measurement impulses received at the node and transmits the time offset information as an impulse signal.

In this case, the time offset may be calculated based on the measurement impulse received earliest at the node or may be calculated by using the time difference between sequentially received measurement impulses.

In this case, the base station receiving the time offset information from the node may be one predetermined base station or may be two or more base stations, and the time offset information may include base station IDs corresponding to the measurement impulses of which each offset calculation is based on.

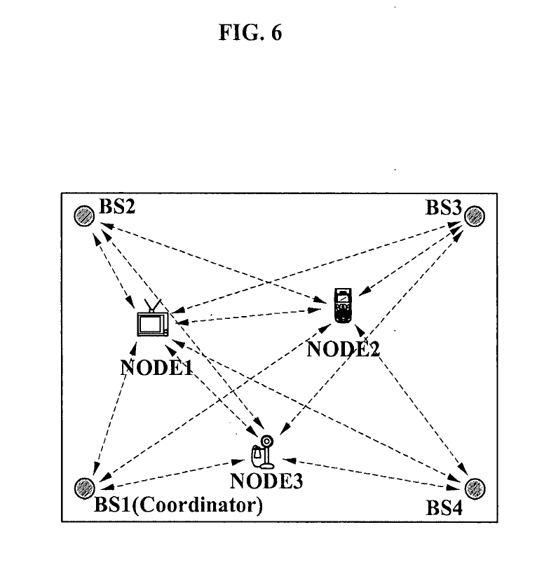

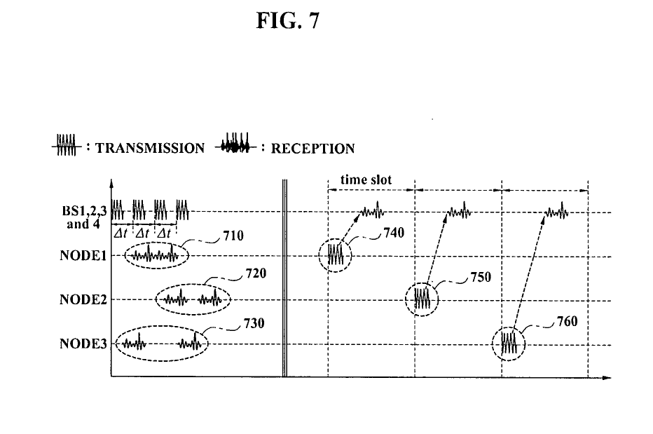

In this case, the time offset information received from the node may be received in a time slot previously assigned to the node. Namely, in the case of a multi-node environment, time offset information calculated at a node may be transmitted to a base station in a time slot previously assigned to the node, which will be described in detail by referring to FIGS. 6 and 7.

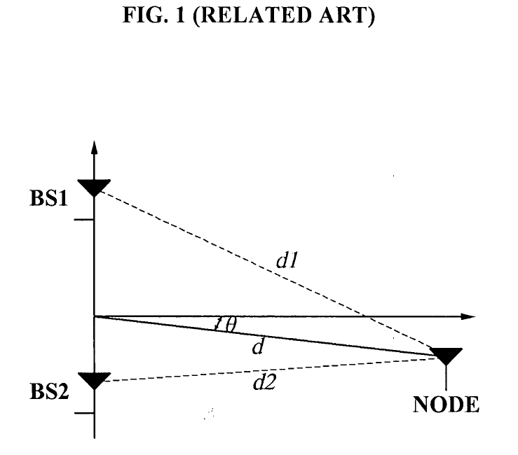

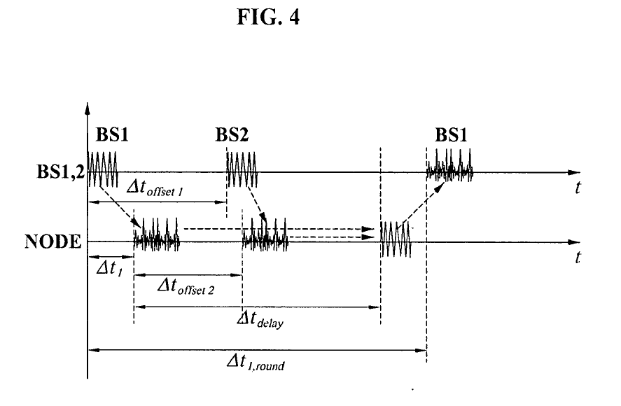

The operations of the node position measurement method according to an exemplary embodiment of the present invention will be described in detail by referring to FIGS. 1 and 4.

FIG. 4 is a waveform diagram with respect to time, illustrating the node position measurement method according to an exemplary embodiment of the present invention, applied to the system configuration of FIG. 1. Namely, FIG. 4 is a waveform diagram with respect to time when there are two base stations BS1 and BS2.

Referring to FIG. 4, when the base station BS1 transmits a measurement impulse for measuring a position of a node, the node receives the measurement impulse of the base station BS1, and when the base station BS2 transmits a measurement impulse for measuring a position of the node after a predetermined amount of time Δt_{offset1}, the node receives the measurement impulse of the base station BS2.

Once the node receives the measurement impulses of the base stations BS1 and BS2, the node calculates a time offset Δt_{offset2}, which is the time between the two measurement impulses, and transmits time offset information including the time offset Δt_{offset2} to the base station BS1. In this case, the time offset information may include base station IDs corresponding to the measurement impulses, which are capable of being used to calculate the time offset Δt_{offset2} between the measurement impulses at the base station BS1, and time information Δt_{delay} from a point in time of receiving the measurement impulse of the base station BS1 to a point in time of transmitting the time offset information (hereinafter, referred to as “delay time”).

The base station BS1 calculates the position of the node by using the time offset information received from the node, a round-trip time, and a transmission time interval Δt_{offset1} of the measurement impulses, between the base stations BS1 and BS2. In this case, to measure the position of the node, a distance between the node and each of the base stations BS1 and BS2 and an azimuth of the node have to be known. The azimuth of the node and the distance between the node and each of the base stations BS1 and BS2 may be calculated as Equation 1,

$$\begin{matrix}θ = {cos}^{- 1} \frac{Δ d}{L} & {d}_{1} = \frac{Δ {t}_{round} - Δ {t}_{delay}}{2} \\ {d}_{2} = {d}_{1} - Δ {d}_{offset} & Δ {d}_{offset} = c \cdot Δ {t}_{offset} \\ Δ {t}_{offset} = Δ {t}_{offset 1} - Δ {t}_{offset 2} & \end{matrix} \qquad [ Equation 1 ]$$

in which θ is an azimuth, Δd is acquired by d1-d2, L is a distance between the two base stations BS1 and BS2, d1 is a distance between the base station BS1 and the node, d2 is a distance between the base station BS2 and the node, c is speed of light (3·10⁸ m/sec), Δt_{round} is the round-trip time, namely, Δt_{l,round} shown in FIG. 4, Δt_{delay} is a delay time, Δt_{offset1} is the transmission time interval of the measurement impulse between the base stations BS1 and BS2, and Δt_{offset2} is an interval between points in time of receiving the measurement impulses at the node.

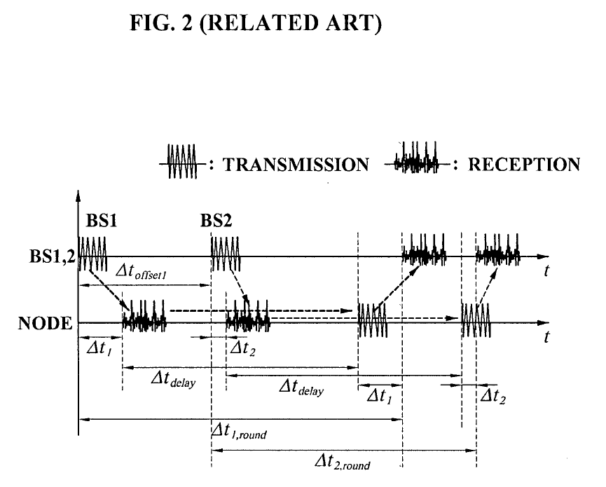

Accordingly, the base station BS I may ascertain the position of the node by using data included in the time offset information received from the node and Equation 1. In this case, comparing with the conventional method shown in FIG. 2, a time for measuring the position of the node may be reduced since a time for transmitting a signal to the base station BS2 is reduced. Accordingly, comparing with the conventional method, a number of nodes whose position may be measured at the same time increases, thereby improving performance of the system and reducing power consumption as well as reducing cost.

The node position measurement method according to an exemplary embodiment of the present invention may show more excellent performance in a multi-node environment of measuring positions of a plurality of nodes.

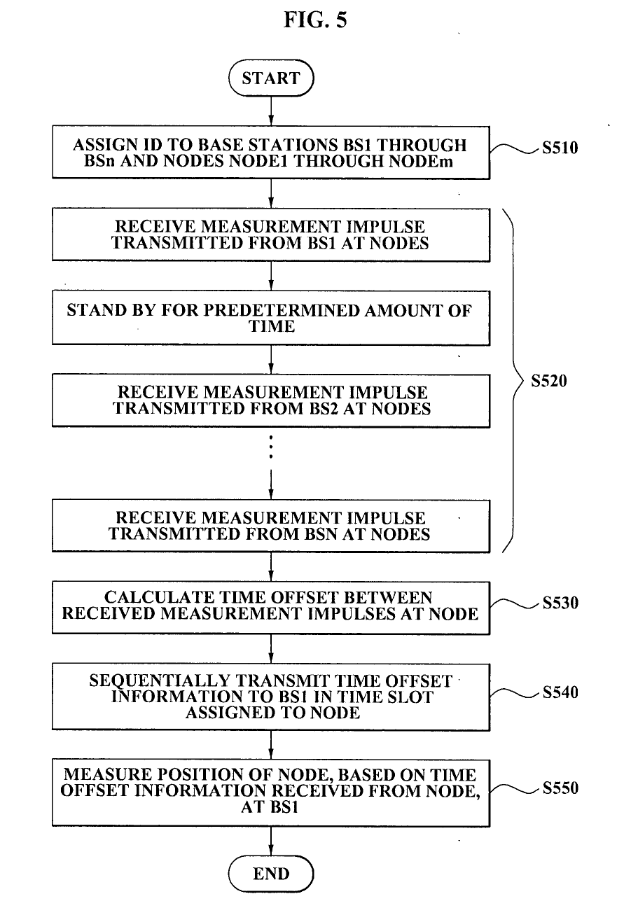

FIG. 5 is a flowchart illustrating a node position measurement method in a multi-node environment according to an exemplary embodiment of the present invention. Referring to FIG. 5, an ID is assigned to a plurality of base stations BS1 through BSn and a plurality of nodes node1 through nodem in operation S510, measurement impulses corresponding to the plurality of base stations BS1 through BSn are sequentially transmitted in a predetermined order at a predetermined time interval and the node receives the measurement impulses in operation S520, the node calculates a time offset between the received measurement impulses and transmits time offset information to the base station BS1 in operations S530 and S540, and the base station BS1 measures a position of the node by using the time offset information received from the node in operation S550.

In this case, even though the time offset information transmitted from the node is received at the base station BS1, any one or more of the base stations BS1 through BSn may receive the time offset information.

Referring to FIG. 5, the plurality of base stations BS1 through BSn and the plurality of nodes node1 through nodem receives the ID from a control apparatus controlling the system, such as the base station BS1 established as a coordinator or an ID assignment apparatus in operation S510.

After receiving the ID, to measure the position of the node, the measurement impulse is transmitted to the base station BS1 established as the coordinator, through the base station BSn at the predetermined time interval. Namely, when the base station BS1 transmits the measurement impulse, the nodes node1 through nodem receive the measurement impulse of the base station BS1. When the base station BS2 transmits the measurement impulse after the predetermined amount of time, the nodes node1 through nodem receive the measurement impulse of the base station BS2. The above process is repeatedly performed to the base station BSn in operation S520.

The nodes node1 through nodem calculate the time offset between the measurement impulses by using the measurement impulses received from the base stations BS1 through BSn and transmits the time offset information including the calculated time offset, to the base station BSI in operations S530 and S540. In this case the order of transmitting the time offset information to the base station BS1 may be previously determined such as an order from node1 to the nodem, and the time offset information may be transmitted in the time slot previously assigned to each of the nodes node 1 through nodem.

The base station BS1 measures the positions of the nodes node1 through nodem by using the time offset information received from the nodes node1 through nodem in operation S550. The position of the node is measured by using the time offset between the measurement impulses and the delay time included in the received time offset information and the round-trip time of the base station BS1.

FIGS. 6 and 7 are diagrams illustrating the node position measurement method in the multi-node environment, shown in FIG. 5. FIG. 6 is a diagram illustrating a system including four base stations BS1 through BS4 and three nodes node1 through node3, and FIG. 7 is a waveform diagram with respect to time, illustrating the method shown in FIG. 6. As shown in FIG. 6, since the base station BS1 performs as a coordinator, the base station BS1 received time offset information from a node to measure a position of the node.

The process of measuring the position of the node at the base station BS1, shown in FIG. 6, will be described by referring to FIG. 7. The base station BS1 transmits a measurement impulse, and the nodes node1 through node3 receive the measurement impulse of the base station BS1. After a predetermined amount time At passes, the base station BS2 transmits a measurement impulse and the nodes node1 through node3 receive the measurement impulse of the base station BS2. After the predetermined amount of time Δt passes, the base station BS3 transmits a measurement impulse and the nodes node1 through node3 receive the measurement impulse of the base station BS3.

The nodes node1 through node3 calculate a time offset between the measurement impulses by using measurement impulses 710 through 730 received at each of the nodes node1 through node3. For example, a difference between a point in time of receiving the measurement impulse of the base station BS 1 and a point in time of receiving the measurement impulse of another base station is calculated, and time offset information 740 through 760 including the calculated time offset and a delay time are transmitted to the base station BS1. Obviously, a process of calculating the time offset is performed at each of the nodes node1 through node3, and a base station ID corresponding to the measurement impulse, which is capable of calculating the time offset, is included in the time offset information. In this case, the node transmits the time offset information to the base station BS1 in a previously assigned time slot.

The base station BS1 receives the time offset information of each of the nodes node1 through node3, transmitted in the assigned time slot and measures positions of the nodes node1 through node3 by using data included in the time offset information of the nodes node1 through node3 and a round-trip time of the measurement impulse of the base station BS1, and the predetermined amount of time Δt.

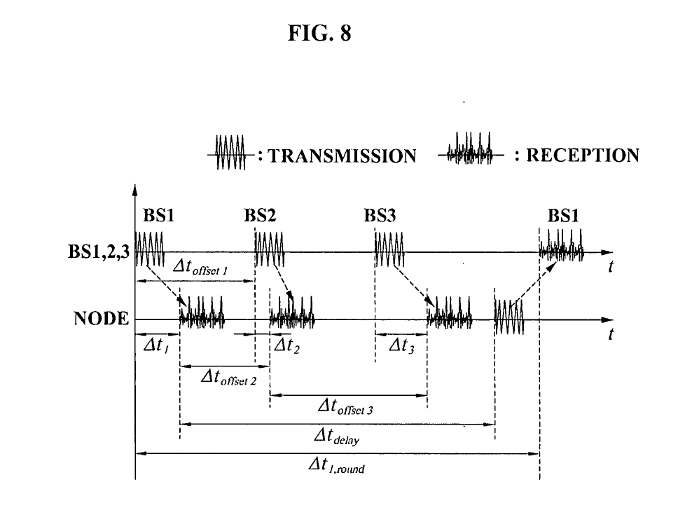

FIG. 8 is a waveform diagram with respect to time, illustrating the node position measurement method according to an exemplary embodiment of the present invention. In FIG. 8, a system includes three base stations BS1 through BS3. In this case, even though a plurality of nodes may exist, one node is displayed to describe a calculation process for measuring a position of the node.

In this case, time offset information of the node, received at the base station BS1, includes a time difference Δt_{offset2} between points in time of receiving measurement impulses of the base stations BS1 and BS2, a time difference Δt_{offset3} between points in time of receiving measurement impulses of the base stations BS2 and BS3, a delay time Δt_{delay}, and a base station ID corresponding to each of the measurement impulses capable of being used to calculate a time offset.

Referring to FIG. 8, a process of calculating a distance between the base station BSI and the node, a distance between the base station BS2 and the node, and a distance between the base station BS3 and the node will be described. In this case, the distance between the node and each of the base stations BS1 through BS3 may be acquired by calculating Δt₁, Δt₂, and Δt₃.

The base station BS1 extracts information from the time offset information received from the node and calculates the distance between the node and the each of the base stations BS1 through BS3.

The distance between the node and the base station BS1 and the distance between the node and the base station BS2 may be acquired by d1 and d2 of Equation 1. In this case, Δt_{round} shown in Equation 1 is Δt_{l,round} shown in FIG. 8. Accordingly, a process of calculating the distance between the node and the base station BS3 will be described. The distance d3 between the node and the base station BS3 is calculated as Equation 2.

d3=d2−Δd_{offset13}

Δd_{offset13}=c·Δt_{offset13}

Δt_{offset13}=Δt_{offset1}−Δt_{offset3} [Equation 2]

As shown in Equation 2, the distance d3 between the node and the BS3 may be calculated by using d2 calculated by Equation 1, the time offset information Δt_{offset3} received from the node, and a transmission time interval Δt_{offset13} of the measurement impulses between the base stations. Specifically, since a time used for transmitting signals corresponding to the measurement impulses of the base stations BS2 and BS3, received from the node, to the base stations BS2 and BS3 is reduced, a time used for measuring the position of the node is reduced and power consumed for measuring the position of the node is reduced.

As described above, the greater the number of base stations and nodes, the greater performance the node position measurement method according to an exemplary embodiment of the present invention may show. Since a number of transmitted and received signals is reduced as well as having the time offset information transmitted in a previously assigned time slot, a probability of incurring interference between signals is reduced.

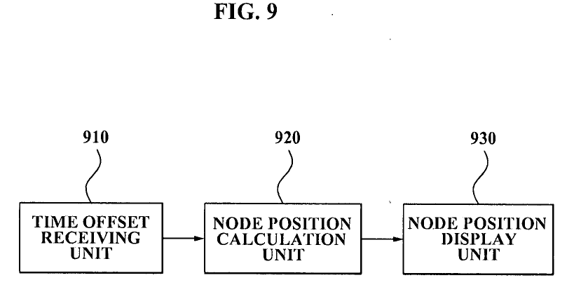

FIG. 9 is a diagram illustrating a configuration of a node position measurement apparatus according to an exemplary embodiment of the present invention. Referring to FIG. 9, the node position measurement apparatus includes a time offset receiving unit 910, a node position calculation unit 920, and a node position display unit 930.

The time offset receiving unit 910 receives time offset information that is a time difference between points in time of receiving measuring impulses corresponding to a plurality of base stations, by at least one node. In this case, the received time offset information may include a time offset between the measurement impulses of the base stations forming a system, a delay time, and a base station ID corresponding to each of the measurement impulses capable of being used to calculate the time offset. In this case, the time offset information is received in a time slot previously assigned to the node.

The node position calculation unit 920 calculates a position of the node, based on the time offset information received from the time offset receiving unit 910. In this case, data for calculating the position of the node may be extracted from the time offset information by the time offset receiving unit 910 or the node position calculation unit 920.

The node position display unit 930 displays the position of the node, calculated by the node position calculation unit 920.

The node position measurement method using time offset information, according to an exemplary embodiment of the present invention, may be embodied as a program instruction capable of being executed via various computer units and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specifically configured to store and perform program instructions. Examples of the program instructions include both machine code, such as produced by a compiler, and files containing high-level language codes that may be executed by the computer using an interpreter. The hardware elements above may be configured to act as one or more software modules for implementing the operations of this invention.

Though identically illustrated in other drawings, the symbols with respect to time, used in the description, such as Δt_{offset1}, Δt_{offset2}, and Δt_{delay}, may have different values.

An aspect of the present invention provides a node position measurement method and apparatus using time offset information, capable of reducing an amount of time required for measuring a position of a node by using time offset information received from the node.

An aspect of the present invention also provides a node position measurement method and apparatus using time offset information, capable of improving performance of an entire system and reducing power consumption by reducing a node position measurement time.

An aspect of the present invention also provides a node position measurement method and apparatus using time offset information, capable of reducing a number of transmissions and receptions of a signal and an amount of time required in measuring a position of a node by transmitting time offset information from all nodes to one predetermined base station.

An aspect of the present invention also provides a node position measurement method and apparatus using time offset information, capable of reducing a probability of incurring interference between signals in a multi-node environment by transmitting time offset information to a base station in a time slot previously assigned to a node.

An aspect of the present invention also provides a node position measurement method and apparatus using time offset information, capable of transmitting and receiving a signal using an impulse signal without requiring an additional device, thereby reducing cost.

Although a few exemplary embodiments of the present invention have been shown and described, the present invention is not limited to the described exemplary embodiments. Instead, it would be appreciated by those skilled in the art that changes may be made to these embodiments without departing from the principles and spirit of the invention, the scope of which is defined by the claims and their equivalents.

What is claimed is:

1. A node position measurement method comprising:
sequentially transmitting measurement impulses corresponding to a plurality of base stations, respectively, to at least one node;
receiving time offset information that is a difference in time of receiving the measurement impulses, from the node which received the measurement impulses; and
measuring a position of the node based on the time offset information.

2. The method of claim 1, wherein the sequentially transmitting measurement impulses comprises:
transmitting a measurement impulse corresponding to a previously established base station from the plurality of base stations; and
sequentially transmitting from the plurality of base stations measurement impulses corresponding to remaining base stations according to a predetermined time interval and a predetermined order.

3. The method of claim 2, wherein, in the receiving time offset information, base stations established as a receiving base station from the plurality of base stations receive the time offset information from the one node.

4. The method of claim 2, wherein the receiving time offset information comprises:
receiving a plurality of the measurement impulses at the node;
calculating a time offset between the measurement impulses, based on the received measurement impulses, at the node; and
receiving the time offset calculated at the node according to a point in time corresponding to the node, at the previously established base station.

5. The method of claim 4, wherein the time offset between the measurement impulses is calculated based on the measurement impulse received from the previously established base station.

6. The method of claim 4, wherein the time offset between the measurement impulses is calculated by a time difference between two sequentially received measurement impulses.

7. The method of claim 4, wherein the node transmits the time offset information in a time slot assigned to the node.

8. The method of claim 4, wherein, in the measuring the position of the node, the position of the node is measured by using the time offset, a round-trip time of the measurement impulse of the previously established base station, and the predetermined time interval.

9. The method of claim 8, wherein, when there are two base stations from the plurality of base stations, the position of the node is measured by using an azimuth of the node and a distance between each base station among the two base stations and the node; and
the azimuth of the node and the distance between each base station and the node are calculated as,
$$\begin{matrix}θ = {cos}^{- 1} \frac{Δ d}{L} & {d}_{1} = \frac{Δ {t}_{round} - Δ {t}_{delay}}{2} \\ {d}_{2} = {d}_{1} - Δ {d}_{offset} & Δ {d}_{offset} = c \cdot Δ {t}_{offset} \\ Δ {t}_{offset} = Δ {t}_{offset 1} - Δ {t}_{offset 2} & \end{matrix} \qquad$$
in which θ is the azimuth, Δd is acquired by d1-d2, L is a distance between the two base stations, d1 is a distance between the previously established base station and the node, d2 is a distance between the other base station and the node, c is a speed of light, Δt_{round} is the round-trip time, Δt_{delay} is a difference in time between a point in time of transmitting the offset information at the node and a point in time of receiving the measurement impulse at the previously established base station, Δt_{offset1} is the predetermined time interval, and Δt_{offset2} is an interval between points in time of receiving the measurement impulses.

10. The method of claim 1, wherein the time offset information includes a base station identification corresponding to the measurement impulses that become a basis of calculating an offset.

11. A computer-readable recording medium in which a program for executing a node position measurement method is recorded, the method comprising:
sequentially transmitting measurement impulses corresponding to a plurality of base stations, respectively, to at least one node;
receiving time offset information that is a difference in time of receiving the measurement impulses, from the node which received the measurement impulses; and
measuring a position of the node based on the time offset information.

12. A node position measurement apparatus comprising:
a time offset information receiving unit which receives time offset information that is a time difference of receiving measurement impulses corresponding to a plurality of base stations, from at least one node; a node position calculation unit which calculates a position of the node, based on the time offset information; and
a node position display unit which displays the position of the node.

13. The apparatus of claim 12, wherein the time offset information receiving unit receives the time offset information in a time slot assigned to the node.

14. The apparatus of claim 12, wherein the node position calculation unit calculates the position of the node using the time offset information received from the node, a time interval of transmitting the measurement impulse between the base stations, and a round-trip time.
